(19) United States
(12) Patent Application Publication
(10) Pub. No.: US 2015/0280316 A1
(43) Pub. Date: Oct. 1, 2015

(54) VEHICLE ANTENNA WITH LIGHT-EMITTING BODY

(71) Applicant: KABUSHIKI KAISHA HONDA LOCK, Miyazaki-shi, Miyazaki (JP)

(72) Inventor: Hiroki Iso, Miyazaki (JP)

(21) Appl. No.: 14/435,576

(22) PCT Filed: Jul. 4, 2013
(86) PCT No.: PCT/JP2013/068414

§ 371 Date: Apr. 14, 2015

(30) Foreign Application Priority Data
Oct. 16, 2012 (JP) 2012-228895

(51) Int. Cl. H01Q 1/32; B60Q 1/44; B60Q 1/26

(52) U.S. Cl. CPC H01Q 1/3275; B60Q 1/2611; B60Q 1/44

(57) ABSTRACT

Provided is a vehicle antenna with a light-emitting body that allows improving visibility while maintaining the characteristic of an antenna element.

The vehicle antenna with a light-emitting body includes: a base 21; an antenna element 42 arranged on the base 21; a light-emitting body 52 that is arranged on a peripheral edge portion of the base 21 and positioned below the antenna element 42; and a casing 24 that covers the antenna element 42 from an upper side so as to house the antenna element 42. The casing 24 is formed of a light transmissive material, and a lower-end opening edge of the casing 24 is arranged at an upper side of the peripheral edge portion of the base 21.

### TECHNICAL FIELD

The present invention relates to a vehicle antenna with a light-emitting body.

### BACKGROUND ART

Conventionally, an antenna device is mounted on the roof panel of a vehicle body to receive the signals of television, radio, and similar service. Mounting an antenna device for receiving GPS, an antenna device for receiving the signal transmitted from a FOB key, and similar device on the roof panel in the future is under consideration. As this antenna device, what is called a shark fin antenna, which has a fin-shaped casing, disposed on the roof panel to protrude upward, is known. Inside this fin-shaped casing, an antenna element is housed.

Here, for example, Patent Literature 1 discloses the following configuration. In this configuration, a light-emitting, body such as an LED is mounted on the outer surface of the casing. This light-emitting body lights in conjunction with: lighting of a turn-signal light as an answer back to a turn signal operation and a FOB-key operation (for example, a locking-unlocking operation of a door lock and a car-find operation for confirming the position of own vehicle in a large parking area or similar place); and lighting of a brake light by a brake operation. According to this configuration, the light-emitting body can be arranged in a relatively high position in the vehicle body. Accordingly, various driving operations of the vehicle can be notified to the vehicle (driver) and the person nearby. Thus, it is said to be possible to improve the convenience and similar performance.

### CITATION LIST

### Patent Literature

PATENT LITERATURE 1: SP-A-2011-245934

### SUMMARY OF INVENTION

### Problems to be Solved by the in Invention

FIG. 7 is a schematic cross-sectional view for describing a conventional antenna device. FIG. 8 is a diagram illustrating the directivity of the conventional antenna device. In an antenna device 100 of Patent Literature 1 described above, as illustrated in FIG. 7, a light-emitting body 101 is disposed on the outer surface of a casing 102 (in the drawing, one light-emitting body is illustrated on the top of the casing 102). Accordingly, within the casing 102, an antenna element 103 and wiring 104 for the light-emitting body 101 are provided together. Therefore, the antenna element 103 is affected by a metal line, which is the wiring 104 of the light-emitting body 101. As a result, there is a possibility that the antenna element 103 cannot provide the original characteristic.

For example, as illustrated in FIG. 7 and FIG. 8, in the case where the wiring 104 of the light-emitting body 101 is extended to the rear of the antenna element 103, the antenna directivity particularly at the rear of the antenna element 103 is reduced. As a result, there is a problem where a mill point N (the point where the communication sensitivity is significantly reduced) occurs at the rear of the antenna element 103 or similar problem. In the case where the mounted antenna element 103 is a radio receiving antenna or similar antenna, the receiving sensitivity is significantly reduced depending on the direction of the vehicle. In the case where the antenna element 103 is the antenna for receiving the transmission signal from the FOB key, there is a possibility that the communication between the FOB key and the antenna element 103 is interfered even when a user operates the FOB key from a null direction (for example, the rear of the vehicle) (see the arrow in FIG. 8). Thus, the communication might not be satisfied.

Therefore, the present invention provides a vehicle antenna with a light-emitting body that allows improving the visibility while maintaining the characteristic of an antenna element.

### Solutions to the Problems

A vehicle antenna with a light-emitting body according to the present invention employs the following configuration.

(1) The vehicle antenna with a light-emitting body includes: a base; an antenna element arranged on the base; a light-emitting body that is arranged on a peripheral edge portion of the base and positioned below the antenna element; and a casing that covers the antenna element from an upper side so as to house the antenna element. The casing is formed of a light transmissive material, and a lower-end opening edge of the casing is arranged at an upper side of the peripheral edge portion of the base.

With this configuration, the light-emitting body is arranged in the peripheral edge portion of the base and below the antenna element. Accordingly, the wiring for the light-emitting body is arranged in the position lower than that of the antenna element. Therefore, the antenna element is less likely to be affected by the wiring for the light-emitting body or si ember. Thus, the characteristic of the antenna element can properly be maintained. In this case, the wiring for the light-emitting body does not interfere with the communication like the conventional technique. Accordingly, this allows preventing the occurrence of the null point or similar problem. Thus, satisfactory communication sensitivity can be provided over all the directions. Additionally, the light-emitting body is arranged on the peripheral edge portion of the base and the lower-end opening edge of the casing is brought into contact with the peripheral edge portion of the base. Accordingly, the light-emitting body and the lower-end opening edge of the casing are arranged to be close to or overlap with each other. In this case, the transmission of the light flux emitted from the light-emitting body in the casing causes the state where the entire casing emits light. Accordingly, the visibility can be improved. Thus, while the characteristic of the antenna element is maintained, the visibility can be improved.

(2) In the vehicle antenna with the light-emitting body according to the aforementioned (1), within the casing, an interior material formed of a light blocking material is preferably arranged at an inner side of the light-emitting body.

With this configuration, the interior material formed of the light blocking material is arranged at the inner surface of the casing. Additionally, the external appearance of the casing can be properly maintained, and the light flux emitted from the light-emitting body can efficiently emit light outward. Thus, the visibility can be further improved.

(3) In the vehicle antenna with the light-emitting body according to the aforementioned (1) or (2), the light-emitting body is preferably arranged in a portion overlapping with a lower-end opening edge of the casing in the peripheral edge portion of the base.

With this configuration, the light-emitting body is arranged in the portion overlapping with the lower-end opening edge of the casing in the base. Accordingly, the light flux emitted from the light-emitting body can be efficiently transmitted to the casing. Thus, the visibility can be improved.

### Effects of the Invention

The present invention allows preventing the occurrence of the null point or similar problem, and allows providing satisfactory communication sensitivity over all the directions. Furthermore, by the transmission of the light flux emitted from the light-emitting body in the casing, the entire casing is seen to emit light. Accordingly, while the characteristic of the antenna element is maintained, the visibility can be improved.

### BRIEF DESCRIPTION OF THE DRAWINGS

FIG. 1 is a partial perspective view of a vehicle viewed obliquely from the rear side.

FIG. 2 is an exploded perspective view an antenna device according to this embodiment.

FIG. 3 is a cross-sectional view of the antenna device corresponding to the line A-A in FIG. 2.

FIG. 4 is a view on arrow B in FIG. 2.

FIG. 5 is a diagram illustrating the directivity of the antenna device.

FIG. 6 is an enlarged view of a portion corresponding to the C portion in FIG. 3, the view illustrating another configuration of this embodiment.

FIG. 7 is a schematic cross-sectional view for describing a conventional antenna device.

FIG. 8 is a diagram illustrating the directivity of the conventional antenna device.

### DESCRIPTION OF EMBODIMENTS

The following describes the embodiments of the present invention based on the drawings. In this embodiment, the case where a vehicle antenna 13 (hereinafter referred to simply ply as the antenna device 13) with alight-emitting body of the present invention is mounted on a four-wheeled vehicle 10 will be described as an example.

### (Vehicle)

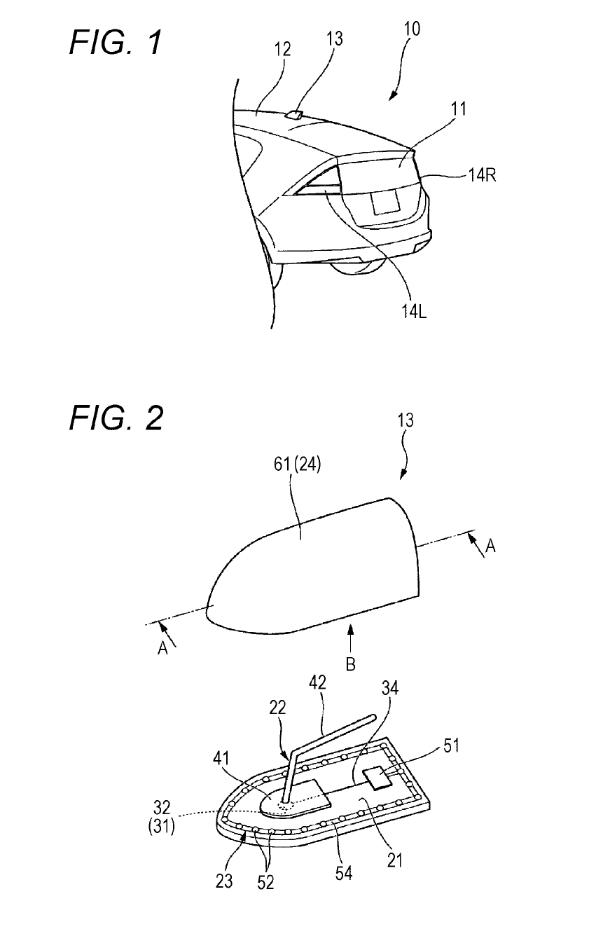

FIG. 1 is a partial perspective view of a vehicle viewed obliquely from the rear side. Here, the directions such as front-to-back and side-to-side directions in the following description are the same as those directions in the vehicle unless otherwise stated. As illustrated in FIG. 1, on the vehicle 10 (hereinafter referred to also as the own vehicle 10) in this embodiment, the antenna device 13 is installed in the rear end portion of a roof panel 12 of a vehicle body 11 and in the center of the right-left direction.

Here, on both right and left sides in the front portion and the rear portion of the vehicle body 11, turn-signal lights (a right-side turn-signal light 14R and a left-side turn-signal light 14L) are arranged (in the drawing, only the turn-signal lights 14R and 14L in the rear portion are illustrated). The turn-signal lights 14R and 14L cause blinking of the turn-signal light in the moving direction corresponding to the turn signal operation of the driver so as to indicate the moving direction of the own vehicle 10 to the driver of the following vehicle, pedestrians, and similar person during turning right and left or lane changing.

The turn-signal lights 14R and 14L also function as hazard lights for indicating that the own vehicle 10 is a traffic obstacle (hazard), parked or stopped, and in a similar state. In this case, there is provided a mechanism that blinks both the turn-signal lights 14R and 14L. Here, the vehicle 10 in this embodiment is configured such that the hazard light blinks as an answer back when the FOB key, which the user has, is operated (for example, a locking-unlocking operation of a door lock and a car-find operation for confirming the position of the own vehicle 10 in a large parking area or similar place by the FOB key).

### (Antenna Device)

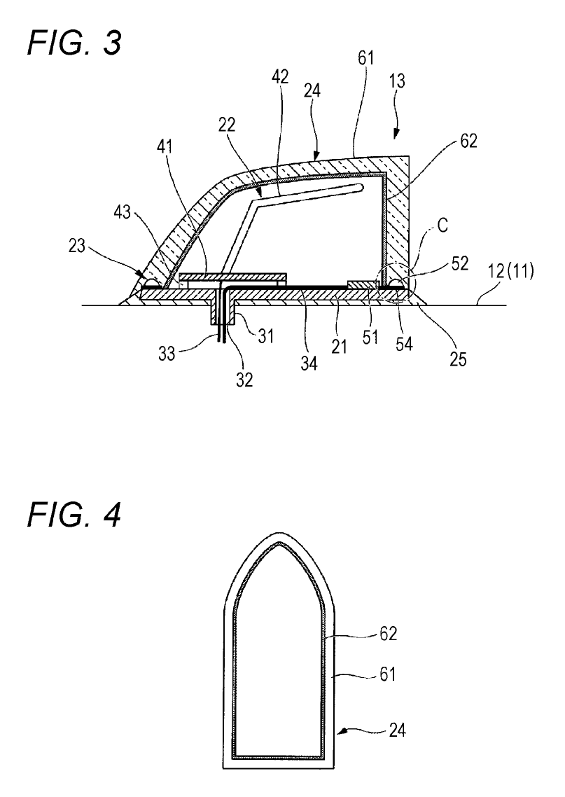

FIG. 2 is an exploded perspective view of the antenna device. FIG. 3 is a cross-sectional view of the antenna device corresponding to the line A-A in FIG. 2. FIG. 4 is a view on arrow B in FIG. 2. As illustrated in FIG. 2 to FIG. 4, the antenna device 13 described above is what is called a shark fin antenna. This shark fin antenna includes: a base 21; an antenna portion 22, which is mounted on the base 21, and a light-emitting portion 23; and a casing 24, which covers the antenna portion 22 and the light-emitting portion 23 from the upper side so as to house these members.

The base 21 is formed in a pentagonal shape in plan view tapered toward the front side. The base 21 is secured on the roof panel 12 sandwiching waterproof rubber 25 (see FIG. 3) between the base 21 and the roof panel 12. In the front portion of the base 21, a boss portion 31 (see FIG. 3) projecting downward is formed. This boss portion 31 is, for example, inserted into a mounting hole (not illustrated) formed on the roof panel 12 so as to be secured inside the roof panel 12. Accordingly, the base 21 is secured to the roof panel 12. In the boss portion 31, a through hole 32 passing through the base 21 in the up-down direction is formed. Accordingly, through this through hole 32, antenna wiring 33 and light-emitting body wiring 34 are drawn into the antenna device 13 (the space enclosed by the base 21 and the casing 24) from the vehicle body 11 side.

The antenna portion 22 receives signals of television, radio, and similar service and communicates with the FOB key. The antenna portion 22 includes an antenna board 41 and an antenna element 42, which is mounted on the antenna board 41. The antenna board 41 is secured above the boss portion 31 on the base 21 via a spacer 43 or similar member. The antenna board 41 is arranged while having a clearance respect to the top surface of the base 21. The antenna wiring 33, which is drawn into the antenna device 13 from the through hole 32 described above, is electrically coupled to the antenna board 41. The base end portion of the antenna element 42 is coupled on the antenna board 41. From the base end portion to the distal end portion of the antenna element 42, this element 42 extends obliquely upward.

The light-emitting portion 23 includes a light-emitting body circuit 51 and a plurality of light-emitting bodies 52, which is formed of LEDs or similar member coupled to this light-emitting body circuit 51. The light-emitting body circuit 51 is secured to the portion located at the rear of the boss portion 31 on the base 21. The above-described light-emitting body wiring 34 is extended on the base 21 through the clearance between the antenna board 41 and the base 21. This wiring 34 is electrically coupled to the light-emitting body circuit 51.

Each light-emitting body 52 is mounted on a board 54 such as a printed circuit board and a flexible printed circuit board. The respective light-emitting bodies 52 are electrically coupled together. The light-emitting bodies 52 are arrayed at intervals over the entire peripheral edge portion on the top surface of the base 21. The light-emitting bodies 52 are each configured to emit a light flux mainly upward. Each light-emitting body 52 is electrically coupled to the above-described light-emitting body circuit 51 via the board 54. Each light-emitting body 52 lights, for example, in conjunction with the turn-signal lights 14R and 14L described above, corresponding to the operation result of the FOB key.

Accordingly, in this embodiment, the antenna element 42 is mounted on the antenna board 41, which is arranged while having the clearance with respect to the base 21. On the other hand, the respective light-emitting bodies 52 are arrayed on the peripheral edge portion of the base 21. Accordingly, the respective light-emitting bodies 52 and the light-emitting body wiring 34 are arranged in the positions lower than that of the antenna element 42.

The casing 24 is formed to become gradually higher and wider toward the rear side of the casing 24. Furthermore, the casing 24 is a hollow member formed in a fin shape tapered upward. Then, the casing 24 is secured to the base 21 while internally housing the antenna portion 22 and the light-emitting portion 23. Specifically, the casing 24 in this embodiment includes a casing body (casing) 61, which constitutes the external appearance of the antenna device 13, and an interior material 62, which is arranged at the inner side from the light-emitting bodies 52.

The casing body 61 is constituted of a material having light permeability, for example, polycarbonate. The lower-end opening edge of the casing body 61 is formed in a shape equivalent to the outer shape of the base 21. In the state where the lower-end opening edge is in contact with the peripheral edge portion of the base 21, the casing 24 and the base 21 are secured together. That is, in this embodiment, the above-described light-emitting bodies 52 are positioned under the lower-end opening edge of the casing body 61. The light-emitting bodies 52 are sandwiched between the lower-end opening edge of the casing body 61 and the peripheral edge portion of the base 21. Accordingly, the configuration where the light flux emitted from the light-emitting body 52 is transmitted within the casing body 61 is employed. Here, in the portion facing the light-emitting body 52 at the lower-end opening edge of the casing body 61, it is preferred to form a housing portion (depressed portion) that houses the light-emitting body 52.

The interior material 62 is formed of a light blocking material. Accordingly, the inside of the casing 24 is not viewable from outside. Specifically, the interior material 62 in this embodiment is configured such that the inner surface of the casing body 61 is painted in a desired color (for example, the color same as the color of the vehicle body 11).

### (Operations)

The following describes the operations of the antenna device 13 described above. In the following description, the answer back function to the FOB-key operation will be described. When a command signal (for example, the command signals of the locking-unlocking operation of the door lock, the car-find operation, and similar operation) transmitted from the FOB key is received at the vehicle 10 side (the antenna element 42), both the turn-signal lights 14R and 14L blink as the answer back to the command signal. At this time, the light-emitting body 52 also lights. At this time, by the transmission of the light flux emitted from the light-emitting body 52 within the casing body 61 of the casing 24, the entire casing body 61 is seen to emit light. Thus, by the lighting of the turn-signal lights 14R and 14L and the light-emitting bodies 52 based on the operation result of the FOB key, the operation result can be promptly determined, for example, in the case where the locking-unlocking operation of the door lock is performed from a long distance and in the case where the place where the own vehicle 10 is parked is confirmed in a large parking area.

In this case, in this embodiment, the antenna device 13 disposed at the roof panel 12 includes the light-emitting portion 23. Thus, the visibility of the above-described answer back function can be improved. That is, the light-emitting portion 23 is arranged in the relatively high position in the vehicle 10. Accordingly, even in the case where the turn-signal lights 14R and 14L are blind spots when viewed from the user or similar case, the operation result of the FOB key can be determined based on the lighting of the light-emitting body 52.

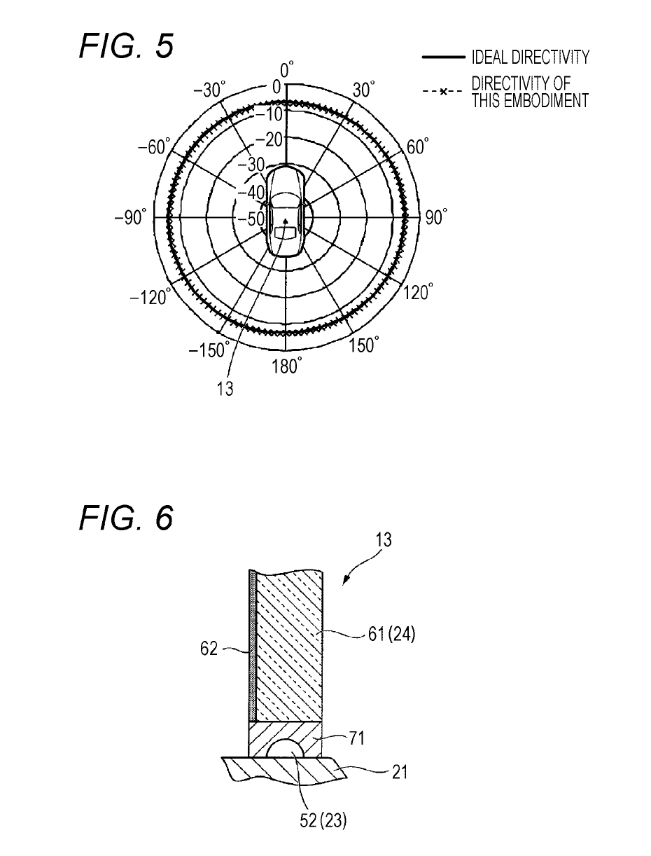

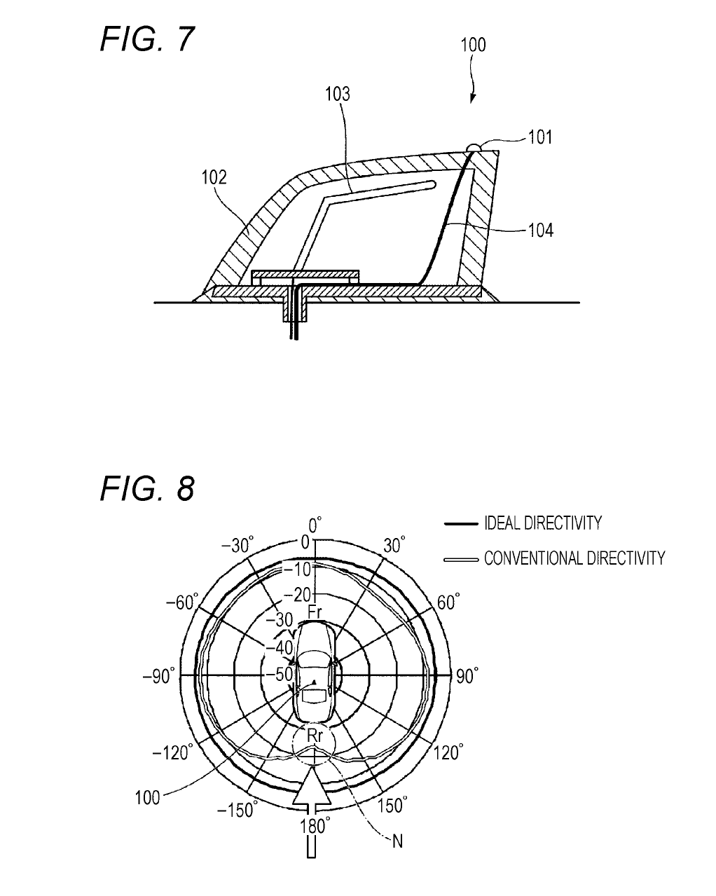

Moreover, this embodiment employs the configuration here the light-emitting bodies 52 are arranged in the peripheral edge portion of the base 21 and below the antenna element 42. With this configuration, the light-emitting body wiring 34 is arranged in the position lower than that of the antenna element 42. Accordingly, the antenna element 42 is less likely to be affected by the light-emitting body wiring 34 or similar member. Thus, the characteristic of the antenna element 42 can properly be maintained. In this case, in this embodiment, the wiring 104 for the light-emitting body 101 does not interfere with the communication like the conventional technique. Accordingly, this allows preventing the occurrence of the null point N or similar problem and, as illustrated in FIG. 5, allows providing satisfactory communication sensitivity over all the directions of the vehicle 10.

The light-emitting body 52 is arranged on the peripheral edge portion of the base 21 and brings the lower-end opening edge of the casing 24 into contact with the peripheral edge portion of the base 21. Accordingly, the light-emitting portion 23 and the lower-end opening edge of the casing 24 are arranged to be close to or overlap with each other. In this case, the transmission of the light flux emitted from the ht-emitting portion 23 (the light-emitting bodies 52) within the casing body 61 causes the state where the entire casing body 61 emits light. Thus, the visibility can be improved. In particular, in this embodiment, the light-emitting bodies 52 are arranged in the portion overlapping with the lower-end opening edge of the casing body 61 in the base 21. Accordingly, the light flux emitted from the light-emitting bodies 52 can be efficiently transmitted to the casing body 61. Thus, the visibility can be further improved.

Furthermore, in this embodiment, the interior material 62 formed of the light blocking material is arranged on the inner surface of the casing body 61. Thus, the external appearance of the casing 24 can be properly maintained. Furthermore, the light flux emitted from the light-emitting portion 23 can efficiently emit light outward. Thus, the visibility can be further improved.

The embodiment of the present invention has been described in detail above with reference to the drawings. The specific configuration is not limited to this embodiment. The configurations also include the design change without departing from the scope of the present invention and similar change. For example, in the above-described embodiment, the case where the antenna device 13 employs the shark fin antenna has been described. This, however, should not be construed in a limiting sense, and a pole antenna can be used.

In the above-described embodiment, the configuration where the inner surface of the casing body 61 is painted as the interior material 62 has been described. This, however, should not be construed in a limiting sense. It is possible to, for example, form the casing body 61 formed of the light transmissive material and the interior material 62 formed of the light blocking material in two colors. It is also possible to form the casing body 61 and the interior material 62 separately and provide a clearance between both members. Furthermore, it is possible to employ the configuration where the interior material 62 is not provided.

In the above-described embodiment, the configuration where the light-emitting bodies 52 are arranged under the lower-end opening edge of the casing body 61, that is, in the position overlapping with the lower-end opening edge has been described. Employing the configuration where the light flux emitted from the light-emitting body 52 is transmitted within the casing body 61 allows changing the design of the positional relationship between the lower-end opening edge of the casing body 61 and the light-emitting body 52 as necessary. For example, it is possible to employ the configuration where the light-emitting body 52 is arranged at the inner side (for example, in the clearance between the casing body 61 and the interior material 62) of the casing body 61 in the peripheral edge portion of the base 21. As another example, it is possible to employ the configuration where the light-emitting body 52 is arranged at the outer side of the casing body 61.

In the above-described embodiment, the description has been given of the configuration where the housing portion, which houses the light-emitting bodies 52, is formed in the portion, overlapping with the light-emitting body 52, in the lower-end opening edge of the casing body 61 and where the lower-end opening edge of the casing body 61 is secured to the base 21. This, however, should not be construed in a limiting sense. For example, as illustrated in FIG. 6, it is possible to employ the configuration where the lower-end opening edge of the casing body 61 and the base 21 are secured while sandwiching a spacer 71 (for example, an adhesive or similar material) having light permeability so as to house the light-emitting body 52 within this spacer 71.

The design of the color and the shape of the light-emitting body 52 and similar parameter can be changed as necessary. In above-described embodiment, the configuration where the light-emitting bodies 52 are arranged to project upward from the top surface of the base 21 has been described. This, however, should not be construed in a limiting sense. It is also possible to employ the configuration where the light-emitting bodies 52 are buried in the base 21. Also in the above-described embodiment, the configuration where the light-emitting bodies 52 are disposed over the whole circumference of the base 21 has been described. This, however, should not be construed in a limiting sense. The light-emitting bodies 52 may be arranged only in a part of the base 21.

Furthermore, in the above-described embodiment, the configuration where the light-emitting, body 52 emits light according to the operation result of the FOB key has been described. This, however, should not be construed in a limiting sense. It is also possible to employ the configuration where the light-emitting body 52 emits light responding to various driving operations (the turn signal operation, the brake operation, and similar operation). Furthermore, in the above-described embodiment, the configuration where the light-emitting body 52 emits light in conjunction with the turn-signal lights 14R and 14L (the hazard lights) has been described. This, however, should not be construed in a limiting sense. The light-emitting body 52 may independently emit light alone. In the above-described embodiment, the case where the antenna device 13 of the present invention is applied to the four-wheeled vehicle has been described. This, however, should not be construed in a limiting sense. The vehicle antenna of the present invention can be applied to a two-wheeled vehicle and a three-wheeled vehicle.

### DESCRIPTION OF REFERENCE NUMERALS

10 Vehicle
13 Antenna device (Vehicle antenna with light-emitting body)
21 Base
24 Casing
42 Antenna element
52 Light-emitting body
62 Interior material

1. A vehicle antenna with a light-emitting body, comprising:
a base;
an antenna element arranged on the base;
a light-emitting body that is arranged on a peripheral edge portion of the base and positioned below the antenna element; and
a casing that covers the antenna element from an upper side so as to house the antenna element, wherein
the casing is formed of a light transmissive material, and
a lower-end opening edge of the casing is arranged at an upper side of the peripheral edge portion of the base.

2. The vehicle antenna with the light-emitting body according to claim 1, wherein
within the casing, an interior material formed of a light blocking material is arranged at an inner side of the light-emitting body.

3. The vehicle antenna with the light-emitting body according to claim 1, wherein
the light-emitting body is arranged in a portion, overlapping with a lower-end opening edge of the casing, in the peripheral edge portion of the base.

4. The vehicle antenna with the light-emitting body according to claim 2, wherein
the light-emitting body is arranged in a portion, overlapping with a lower-end opening edge of the casing, in the peripheral edge portion of the base.
